(19) United States
(12) Patent Application Publication
(10) Pub. No.: US 2017/0021579 A1
(43) Pub. Date: Jan. 26, 2017

(54) MOUNTING DEVICE FOR SECURING A TIRE MODULE

(71) Applicant: HUF HÜLSBECK & FÜRST GMBH & CO. KG, Velbert (DE)

(72) Inventors: Daniel Bambeck, Essen (DE); Peter Czech, Duesseldorf (DE); Juergen Luetzner, Hann (DE)

(73) Assignee: Huf Huelsbeck & Fuerst GmbH & Co. KG, Velbert (DE)

(21) Appl. No.: 15/124,645

(22) PCT Filed: Feb. 5, 2015
(86) PCT No.: PCT/EP2015/052371

§ 371 Date: Sep. 8, 2016

(30) Foreign Application Priority Data
Mar. 18, 2014 (DE) 10 2014 103 674.3

(51) Int. Cl. B29D 30/00; B60C 23/04; H01Q 1/22; B29C 65/18

(52) U.S. Cl. CPC B29D 30/0061; B29C 65/18; B60C 23/0493; H01Q 1/2241; H01Q 1/225; B29D 2030/0072; B29L 2030/00

(57) ABSTRACT

A mounting device for securing a tire module, such as a tire pressure sensor, to an inner surface of a pneumatic tire for vehicles includes a stand from which a supporting arm extends. A setting head, which can be lowered with a predetermined force, is attached to the longitudinal end of the supporting arm facing away from the stand. The setting head includes a holding device with which the tire module can be releasably held in a clamping manner on the setting head during the process of securing. At least one heating element is provided for securing the tire module to the inner surface of the pneumatic tire in a material bonded manner.

The invention relates to a mounting device for securing a tire module, in particular a tire pressure sensor, to an inner surface of a pneumatic tire for vehicles, having a stand, from which a supporting arm extends, wherein a setting head that can be lowered with a pre-determinable force is attached to the longitudinal end of the supporting arm facing away from the stand.

Tire modules for attachment to an inner surface of a pneumatic tire for vehicles are known from the prior art. By way of example, DE 10 2012 007 071 A1 discloses such a tire module, having a device for measuring and/or monitoring the air pressure in a tire, wherein the device is cast and encapsulated with casting compound, and accommodated in a hat-shaped mount. The encompassing edge of the hat-shaped mount serves thereby to secure the tire module to the inner surface of the pneumatic tire, and can be secured to the inner surface, for example, by means of adhesive or vulcanization. The difficulty with all tire modules that have become know is the securing thereof to the inner surface of the pneumatic tire, because the tire modules having the electronic device begin to show signs of detachment after longer periods of operation. There is furthermore the desire on the part of some tire manufacturers to secure the tire module with the electronic devices to the inner surface of a pneumatic tire such that it can be removed in a relatively simple manner after damage has been detected, and replaced with a new one. With the tire module known from DE 10 2012 007 071 A1, when the tire module has been secured by means of vulcanization, the reproducible central and even pressing of the tire module onto the inner surface of the pneumatic tire becomes problematic.

The invention addresses the objective of creating a solution, by means of which a tire module can be reproducibly secured to the inner surface of a pneumatic tire of a vehicle in a structurally simple manner.

With a mounting device of the type referred to in the introduction, the objective is achieved according to the invention in that the setting head has a holding device, with which the tire module can be releasably held on the setting head in a clamping manner during the securing, and at least one heating element for joining the tire module to the inner surface of the pneumatic tire in a material-bonded manner.

Advantageous and functional designs and further developments of the invention can be derived from the respective dependent claims.

A mounting device for securing a tire module, e.g. a tire pressure sensor, to the inner surface of a pneumatic tire is provided by the invention, which is distinguished by a functional structure, and has a simple and economical construction. In particular, the mounting device according to the invention serves to vulcanize tire pressure sensors onto the inner surface of a pneumatic tire. With the mounting device according to the invention, it is possible that for this securing process, the parameters, temperature, attachment pressure and time, can be set in a variable manner, and that furthermore, the pressing of the tire module occurs centrally in the tire, and evenly over the entire circumference of the tire module.

It is provide in the design of the invention that the at least one heating element is created in the form of a PTC heating element. By using at least one PTC heating element, the system comprising the mounting device and the tire module is intrinsically safe, and furthermore does not exceed temperatures of 230° C. when operated over longer time periods.

In order to measure the temperature of the surface onto which the tire module is pressed on the inner surface of the pneumatic tire as precisely as possible, in another design the invention provides that the setting head has at least one temperature sensor, which is disposed on the longitudinal end of the setting head that holds the tire module. The temperature sensor is preferably mounted in a bore-hole on the lowest end of the setting head, which enables a precise measurement of the temperature at the surface where the tire module is joined to the pneumatic tire.

In an advantageous design, the invention provides that the setting head is attached to the supporting arm by means of a cardanic mount. As a result of this special mounting of the setting head, a centered and even pressing of the tire module onto the inner surface of the pneumatic tire is possible. In particular, as a result of the cardanic mounting, bulging and slight irregularities in the pneumatic tire are compensated for.

In order to heat the setting head quickly, it is advantageous when the setting head is designed as a hollow cylinder.

In order to quickly and easily bring a pneumatic tire that is to be provided with a tire module into position, it is provide for in the design of the invention that the supporting arm is pivotably supported on the stand at its longitudinal end facing away from the setting head.

In order to set and check the force with which the setting head of the tire module presses against the inner surface of the pneumatic tire, the design of the invention provides that a scale, in particular an industrial scale, is provided for checking as well as calibrating the pre-determinable force, which scale is disposed beneath the setting head.

In order to always position the center of the tire in the same place with respect to the tire module that is to be secured, it is provided in another design of the invention that centric clamping device designed for a reproducible alignment of a pneumatic tire is disposed beneath the setting head.

The use of compressed air is provided for driving the mounting device. Accordingly, the invention provides in its design that at least one first pneumatic cylinder that lifts the setting head and lowers it with a pre-determinable force is disposed on the supporting arm. The pneumatic cylinder can be designed thereby as cylinder that can be subjected to air pressure from one side and from both sides.

In order to be able to place the pneumatic tires in a simple manner on the mounting device, and remove them therefrom, in another design of invention it is provided that a second pneumatic cylinder is attached to the stand or the supporting arm, for pivoting the supporting arm between a position that raises the setting head and a position that lowers the supporting arm such that is it held substantially transverse to the stand. This pneumatic cylinder can also be designed as a cylinder that can be subjected to compressed air from one side and from both sides.

To ensure that a certain pressure is not exceeded in the pneumatic circuit, or the pneumatic circulation system of the mounting device, it is advantageous when a pressure regulator for setting the system pressure is disposed in the circulation system leading to both pneumatic cylinders. As a result, it is possible to maintain a specific output pressure, despite different pressures at the input end of the system.

In order to clear or block the way for the compressed air to the pneumatic cylinders, or to reverse the flow direction or bleed the lines, the invention provides in another design that a directional control valve is disposed in the circulation system between the pressure regulator and the two pneumatic cylinders, which can be controlled electrically with an power box. It can be controlled manually by a user, for example. As an alternative to the control by a user, the power box can also be designed such that it can be programmed, and process an appropriate program for securing a tire module to a pneumatic tire.

In another design of the invention it is provided that a first and second line exit the directional control valve, wherein a respective line is divided into a branch line leading to the first pneumatic cylinder and a branch line leading to the second pneumatic cylinder, wherein a choke valve is disposed in each of the respective branch lines, for sequential control of the pneumatic cylinders. The choke valves, or reducing valves, respectively, serve as the sequencing control for the mounting device. When the setting head is set or lowered, the flow to the pneumatic cylinder that raises or sinks the setting head is significantly more strongly reduced than the flow to the pneumatic cylinder that pivots the supporting arm. When the setting head is lowered or raised, the setting is inverted accordingly. As a result, a defined temporal behavior of the mounting device can be reproduced when a tire module is secured to a pneumatic tire, without having to use complex control electronics.

Lastly, the design of the invention provides that the power box comprises a thermostat for regulating the temperature of the setting head, a timer for checking the time used for the securing process, a reset button for stopping the securing process, and a start button for initiating the securing process. Consequently, the thermostat (e.g. Tempatron PID500) and a timing module (e.g. Panasonic LT4H), as well as the start and reset button are consolidated in the power box. The thermostat activates a semiconductor relay in order to heat the at least one heating element with approx. 200 W at the setting head to the necessary temperature. The temperature is obtained and maintained very precisely and without overshooting via PID regulator function. The target and actual values are displayed at all times by the power box.

As a matter of course, the features specified above and still to be explained below can be used not only in the respective given combinations, but also in other combinations or in and of themselves, without abandoning the scope of the present invention. The scope of the invention is defined only by the Claims.

Further details, features and advantages of the subject matter of the invention can be derived form the following description in conjunction with the drawings, in which an exemplary embodiment of the invention is depicted by way of example. Therein:

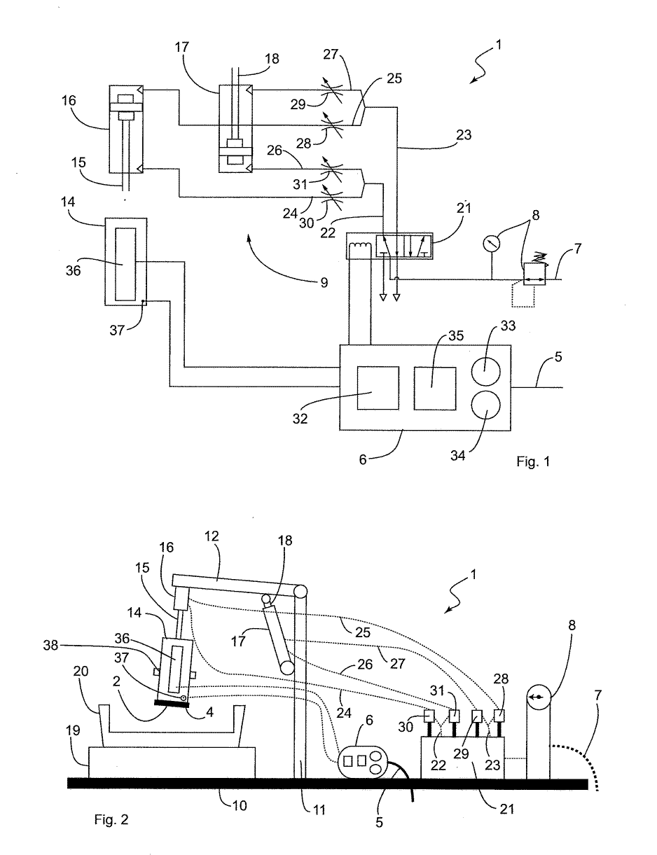

FIG. 1 shows an exemplary pneumatic diagram of the mounting device according to the invention for securing a tire module to the inner surface of a pneumatic tire,

FIG. 2 shows a schematic side view of the mounting device according to the invention, and

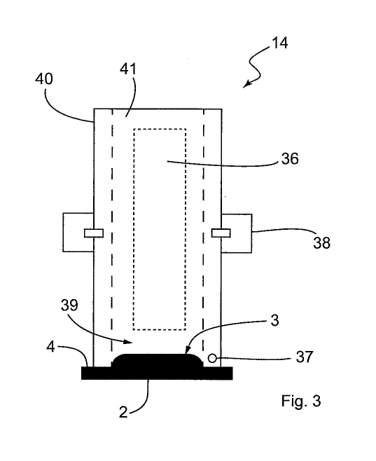

FIG. 3 shows a schematic side view of a setting head of the mounting device.

The mounting device 1 according to the invention is depicted in FIG. 1 in the form of a pneumatic diagram, while in FIG. 2, the mounting device 1 is shown in a schematic side view. The mounting device 1 serves to vulcanize the tire pressure sensors, which shall be referred to below as tire modules 2, to the inner surface of a pneumatic tire for vehicles. A tire module 2 of this type is known from the prior art, e.g. from DE 10 2012 007 071 A1, and comprises an encapsulated electronic device for measuring and/or monitoring the air pressure in the tires, and a hat-shaped mount 3 for accommodating the electronic device. The hat-shaped mount 3 of the tire module 2 has—as can be seen in FIG. 3—an encompassing edge 4, which serves to secure the tire module 2 to the inner surface of the pneumatic tire.

For the process of vulcanizing the tire module 2 to the inner surface of the pneumatic tire, the parameters of temperature, attachment pressure and time must, in general, be able to be set in a variable manner, wherein, furthermore, the pressing thereon must occur centrally in the pneumatic tires, and evenly over the entire circumference of the tire module 2. The mounting device 1 according to the invention achieves this in that an alternating current of 230 V, which is supplied via a voltage line 5 of a power box 6 in FIG. 1, and air pressure of up to 8 bar, which is supplied by a compressed air line 7 of a pressure regulator 8, from which the compressed air is provided to a circulation system 9 (pneumatic system) of the mounting device 1, is required for the vulcanization thereto. By means of the pressure regulator 8, it is ensured that a pressure of 8 bar is not exceeded for the circulation system 9.

The pressure regulator 8 is attached to a base plate 10 made of aluminum, for example, together with other components of the mounting device 1 still to be described in greater detail. Furthermore, a stand 11 of the mounting device 1 is secured to the base plate 10, from which a supporting arm 12 extends. The supporting arm 12 is pivotably supported at a first longitudinal end on the stand 11, and a setting head 14 is attached to the longitudinal end facing away from the stand 11, which holds a tire module 2 that is to be secured to pneumatic tires. The setting head 14 can be lowered toward the base plate 10 using a piston rod 15 of a first pneumatic cylinder 16, in order to press the setting head 14 with a pre-determinable force against the inner surface of a pneumatic tire for securing a tire module 2 thereto, wherein the setting head 15 can likewise be raised again using the first pneumatic cylinder 16. In order to facilitate the placing of a pneumatic tire beneath the setting head 14, the supporting arm 12 is pivotably supported on the stand 11 at its longitudinal end facing away from the setting head 14 such that the longitudinal end of the supporting arm 12, with the setting head 14, can be lowered and raised. For this purpose, a second pneumatic cylinder 17 is provided, the piston rod 18 of which can pivot the supporting arm 12. In the depicted exemplary embodiment, the second pneumatic cylinder 17 is attached to the stand 11, wherein, alternatively, it would also be conceivable to attach it to the supporting arm 12. The supporting arm 12 can be pivoted between a position that raises the setting head 14 and a lowering position that holds the supporting arm 12 in a position substantially transverse to the stand 11.

In order to determine and/or check and/or calibrate the force with which the setting head 14 is pressed against the inner surface of a pneumatic tire, a scale 19 is provided, which is disposed on the base plate 10 beneath the setting head 14. By way of example, an industrial scale may be used for the scale 19. In order to secure a pneumatic tire in place, the mounting device 1 comprises, aside from the scale 19, a centering clamp 20, which is disposed on the scale, and thus beneath the setting head 14, and which enables a reproducible aligning and placement of the pneumatic tire. The centering clamp 20 is designed as a mechanical centering clamp in the depicted exemplary embodiment, wherein, alternatively, the use of a pneumatic centering clamp is also conceivable, which is connected to the circulation system 9 and can be controlled via valve technology.

The pressure regulator 8 is disposed upstream of the two pneumatic cylinders 16, 17, and sets the system pressure, as described above. A directional control valve 21 is disposed thereby between the pressure regulator 8 and the two pneumatic cylinders 16, 17, which can be manually controlled by a user by means of the power box 6. The directional control valve 21 thus serves to control the two pneumatic cylinders 16, 17, in that it assumes various switching settings that are dictated by the power box 6.

A first supply line 22 and a second supply line 23 exit the directional control valve 21. The first supply line 22 divides into a branch line 24 leading to the first pneumatic cylinder 16 and into a branch line 25 leading to the second pneumatic cylinder 17. The second supply line 23 likewise divides into a branch line 26 leading to the first pneumatic cylinder 16 and into a branch line 27 leading to the second pneumatic cylinder 17. A choke valve 28, 29, 30, 31 is disposed in each of the total of four branch lines 24, 25, 26, 27 in order to reduce the pressure and increase the volume of the fluid flowing to the pneumatic cylinders 16, 17. In other words, a respective supply line 22, 23 divides into a branch line 24, 26 leading to the first pneumatic cylinder and a branch line 25, 27 leading to the second pneumatic cylinder 17, wherein a choke valve 28, 29, 30, 31 for sequencing control of the pneumatic cylinder 16, 17 is disposed in each of the respective branch lines 24, 25, 26, 27. The compressed air lines are indicated with a broken line in FIG. 2, and merely illustrate the connection. The supply lines for compressed air from the pressure regulator 8 via the directional control valve 21, which is designed as a 5/2 directional control valve, to the choke valves 28, 29, 30, 31, are controlled electrically by the power box 6. For this, the power box 6 has a timer 32 for checking the duration of the securing process, a reset button 33 for stopping the securing process, and a start button 34 for initiating the securing process.

The power box 6 of the mounting device 1 furthermore comprises a thermostat 35, which serves to regulate the temperature of the setting head 14. The setting head 14 has at least one heating element 36 for attaching the tire module 2 to the inner surface of the pneumatic tire in a material-bonded manner, wherein the heating element 36 is preferably designed as a PTC heating element. In order to determine the temperature of the setting head 14, this heating element has at least one temperature sensor, which is disposed on the longitudinal end of the setting head 14 holding the tire module 2, e.g. in a bore hole.

In order for the setting head 14 to also evenly press the tire module 2 against the inner surface of the pneumatic tire during the securing process, the setting head 14 is attached to the supporting arm 12 by means of a cardanic mount 38, which is merely indicated by way of example in FIGS. 2 and 3. In order to press the tire module 2 onto the inner surface of the pneumatic tire, it is necessary that the tire module 2 that is to be secured to the pneumatic tire is first attached to the setting head 14, and is then released from the setting head 14 after the securing. For this purpose, the setting head 14 of the mounting device 1 has a holding device 39, with which the tire module 2 can be releasably held on the setting head 14 in a clamping manner during the securing. The setting head 14 is designed as a hollow cylinder 40 thereby, as is indicated by the broken line in FIG. 3. The hat-shaped tire module 2 is inserted into the hollow space 41 of the setting head 14, such that the encompassing edge 4 and the undersurface of the hat-shaped tire module 2 are disposed on the longitudinal end of the setting head 14 facing away from the first pneumatic cylinder 16. The hollow cylinder 40 and its hollow space 41 thus form the holding device 39, which securely holds the tire module 2 in a clamping manner. When the setting head 14 is lowered, at least the encompassing edge 4 of the hat-shaped tire module 2 is then pressed onto the inner surface of the pneumatic tire, wherein the heating element 36 of the setting head 14 heats the hollow cylinder 40, and thus the encompassing edge 4 of the tire module 2 to temperature necessary for the material-bonded attachment, such that, together with the pre-determined pressure of the first pneumatic cylinder 16, with which the tire module 2 is pressed against the inner surface of the pneumatic tire, and a pre-determined pressing time, at least the encompassing edge 4 is vulcanized onto the inner surface of the pneumatic tire. Consequently, a material-bonded connection is generated between the tire module 2 and the pneumatic tire, in order to secure the tire module 2. The pressing time for producing the material-bonded connection is approximately one minute.

The mounting device 1 described above is operated using compressed air, wherein the necessary system pressure supplied to the directional control valve 21 is ensured via a pressure regulator 8. The control of the directional control valve 21 occurs thereby by means of the power box 6, such that the two pneumatic cylinders 16, 17 are subjected in a timed manner to compressed air, accordingly. The power box 6 also checks however, whether the heating element 18 on the setting head 14 supplies the necessary heating at the longitudinal end of the setting head 14, in that the temperature sensor 37 is coupled to the power box 6, and can be controlled by it.

In summary, the mounting device 1 according to the invention comprises a skeletal structure composed of a sturdy aluminum plate 10, on which an industrial scale 19, a pivotable supporting arm 12 having the setting head 14, pneumatic elements (e.g. pneumatic cylinders 16, 17 as well as choke valves 28, 29, 30, 31) and a power box 6 are secured.

A centering clamp 20 is mounted on the industrial scale 19, in order to always position the middle of the pneumatic tire in the same place. After clamping the pneumatic tire, the scale 19 can be zeroed, and the force that is applied can later be read out via a display for the power box 6. The force is proportional to the system pressure thereby, which can be adjusted by means of the pressure regulator 8. 2 bars at the pressure regulator correspond thereby to ca. 6 kg pressure, and 6 bars correspond to ca. 15 kg of pressure. The pressure regulator 8 with its display is depicted in FIG. 1, while the display of the pressure regulator is depicted in FIG. 2.

A thermostat 35 (Tempatron PID500), a timer 32 (timer-module, e.g. Panasonic LT4H) and a start button 34 as well as a reset button 33, are consolidated in the power box 6. The thermostat 35 activates a semiconductor relay, in order to heat the at least one heating element 36 with 200 watts at the setting head 14 to the necessary temperature. This is achieve and maintained very precisely via a PID regulator function, without significant overshooting. The target and actual values are displayed at all times. The temperature sensor 27 is mounted in a bore hole on the lowest end of the setting head 14, in order to measure the temperature at the pressure surface, or the application surface, respectively, between the tire module 2 and the inner surface of the pneumatic tire, as precisely as possible. Typical values lie between 120° and 150° C. By using PTC heating elements, the system is intrinsically safe, and does not reach temperatures above 230° C. when subjected to a current for longer periods of time. The timer 32 serves not only as a display, but also activates the pneumatic valve, or the directional control valve 21, respectively. The start button 34 lets the time run, and guides the pneumatic cylinder 16, 17 into the lower position. The reset button 33 or the completion of the set time resets the pneumatic valve, or the directional control valve 21, in order that the setting head 14 is again raised away from the pneumatic tire.

The pivotable supporting arm 12 is moved by the pneumatic cylinder 17 from the open, diagonal position, into a horizontal position. The first pneumatic cylinder 16 subsequently presses the setting head 14 against the tire surface, or the inner surface of the pneumatic tire, respectively, in a precisely vertical direction. A tilted attachment is avoided as a result of this arrangement. Furthermore, the setting head 14 is supported in a cardanic manner, in order to compensate for bulging and slight irregularities in tires. The sequencing control is obtained by means of reduction valves, or choke valves 28, 29, 30, 31. During the setting, the supply to the first pneumatic cylinder 16 with the setting head 15 is reduced significantly more than the supply to the second pneumatic cylinder 17. During the raising, the setting is inverted accordingly. As a result, a defined temporal behavior can be reproduced, without having to use complex control electronics. Furthermore, the setting head 14 is drilled out to form a hollow space, and as a result, automatically clamps the tire pressure sensor, or the tire module 2, respectively, and is tilted approx. 4°, in order to compensate for the deformation of the hat-like tire module 2.

The invention described above is, as a matter of course, not limited to the described and depicted embodiment. It is clear that numerous modifications, obvious to the person skilled in the art with regard to the intended use, can be made to the embodiment depicted in the drawings, without abandoning the scope of the invention as a result. Everything contained in the description and/or depicted in the drawings, including that which is obvious to the person skilled in the art, deviating from the concrete exemplary embodiment, belongs to the invention.

1. A mounting device for securing a tire module, in particular a tire pressure sensor, to an inner surface of a pneumatic tire for vehicles, comprising a stand, from which a supporting arm extends, wherein a setting head that can be lowered with a pre-determinable force is attached to the longitudinal end of the supporting arm facing away from the stand, wherein the setting head has includes a holding device, with which the tire module can be releasably held in a clamping manner on the setting head during the securing, and at least one heating element, for securing the tire module to the inner surface of the pneumatic tire in a material-bonded manner.

2. The mounting device according to claim 1, wherein the at least one heating element is designed as a PTC heating element.

3. The mounting device according to claim 1, wherein the setting head has includes at least one temperature sensor, which is disposed on the longitudinal end of the setting head holding the tire module.

4. The mounting device according to claim 1, wherein the setting head is attached to the supporting arm via a cardanic mount.

5. The mounting device according to claim 1, wherein the setting head is designed as a hollow cylinder.

6. The mounting device according to claim 1, wherein the supporting arm is pivotably supported on the stand at its longitudinal end facing away from the setting head.

7. The mounting device according to claim 1, wherein a scale is provided for checking and calibrating the pre-determinable force, which scale is disposed beneath the setting head.

8. The mounting device according to claim 1, wherein a centering clamp designed for obtaining a reproducible orientation of a pneumatic tire is disposed beneath the setting head.

9. The mounting device according to claim 1, wherein at least one first pneumatic cylinder that raises the setting head and lowers the setting head with a pre-determinable force, is disposed on the supporting arm.

10. The mounting device according to claim 9, wherein a second pneumatic cylinder attached to the stand or the supporting arm is provided for pivoting the supporting arm between a position that raises the setting head and a lowering position holding the supporting arm in a position substantially transverse to the stand.

11. The mounting device according to claim 10, wherein a pressure regulator for setting the system pressure is disposed in the circulation system leading to the two pneumatic cylinders.

12. The mounting device according to claim 11, wherein a directional control valve which can be controlled electrically using a power box is disposed in the circulation system between the pressure regulator and the two pneumatic cylinders.

13. The mounting device according to claim 12, wherein a first supply line and a second supply line exit the directional control valve, wherein a respective supply line divides into a branch line leading to the first pneumatic cylinder, and a branch line leading to the second pneumatic cylinder, wherein a choke valve for sequencing control of the pneumatic cylinders is disposed in each case in the respective branch line.

14. The mounting device according to claim 12, wherein the power box comprises a thermostat for regulating the temperature of the setting head, a timer for checking the duration of the securing process, a reset button for stopping the securing process, and a start button for initiating the securing process.

15. The mounting device of claim 7, wherein the scale comprises an industrial scale.
